(19) United States
(12) Patent Application Publication
(10) Pub. No.: US 2021/0025483 A1
(43) Pub. Date: Jan. 28, 2021

(54) Linear Drive Actuator

(71) Applicant: CREATIVE MOTION CONTROL, Woodinville, WA (US)

(72) Inventor: Shawn Lawlor, Woodinville, WA (US)

(21) Appl. No.: 17/045,588

(22) PCT Filed: Apr. 8, 2019
(86) PCT No.: PCT/US19/26393

§ 371 Date: Oct. 6, 2020

Related U.S. Application Data
(60) Provisional application No. 62/653,814, filed on Apr. 6, 2018.

(51) Int. Cl. F16H 25/22

(52) U.S. Cl. CPC F16H 25/2247; F16H 2025/2031

(57) ABSTRACT

A linear drive actuator (10) that includes a motor 20 coupled to a threaded roller screw shaft (70) with an integrally formed inner race (71) formed on one end used by an fixed thrust bearing (60. Mounted on the roller screw shaft (70) is a roller screw nut (75) that moves axially over the roller screw shaft (70) when the roller screw shaft (70) is rotated. Coupled to roller screw nut (75) is a hollow extension tube (85) that surrounds the roller screw shaft (70). Disposed around the extension tube (85), the roller screw shaft (70) and the roller screw nut (75) is a main housing (100) filled with a lubricant (200). The distal end of the extension tube (85) extends through the end of the main housing (100) and includes an end cap (109) or a connector. Attached to the main tube (100) is an optional volume compensation housing (90) configured to automatically dispense a lubricating fluid (200) into the main housing (90).

### TECHNICAL FIELD

This invention relates to linear drive actuators, and more particularly to portable, compact linear drive actuators.

### BACKGROUND ART

Linear actuators used with portable hand tools commonly include a hydraulic cylinder coupled to an internal or external gas or electricity powered hydraulic pump. The hydraulic cylinder and pump require periodic inspections and maintenance. Also, the hydraulic cylinder and pump limit the size of the actuator.

Electric linear actuators are desirable because they are compact and lightweight. Unfortunately, their load capacity and durability are insufficient for some tasks. Also, linear actuators may include roller screws that need periodic lubrication and produce heat.

### DISCLOSURE OF THE INVENTION

It is an object of the present invention to provide a durable, lightweight, compact and versatile linear drive actuator that uses an internal thrust bearing and a roller screw as the mechanical linear drive mechanism.

It is another object of the present invention to provide such a linear drive actuator with greater lubrication and heat dissipating features.

Disclosed herein is a linear drive actuator that includes an improved linear drive mechanism that uses a roller screw nut mounted on a threaded roller screw shaft coupled to a low clearance, high capacity roller bearing, hereinafter called a thrust bearing. The thrust bearing includes an outer race and a plurality of non-helical grooved rollers axially aligned inside the outer race. The grooves on the rollers mesh with non-helical grooves on an inner race formed near the proximal end of the roller drive shaft. When the roller screw shaft is rotated, the thrust rollers prevents the roller screw shaft from moving axially while the roller screw nut moves axially over the roller screw shaft depending on the rotation of the roller screw shaft.

An extension tube is longitudinally aligned over with the roller screw shaft and coupled to the roller screw nut. As the roller screw nut moves axially over the extension tube, the extension tube moves axially over the roller screw shaft. Surrounding and covering the roller screw shaft, the roller screw nut and the extension tube is a closed main housing filled with a lubricant, such as oil or grease. The extension tube is sufficient in length, so its distal end extends from the distal end of the main housing and connects to an end termination or a tool implement.

The term “integral” refers to the inner race that is formed on or integral with the roller screw shaft. Functionally this eliminates the need for a separate lock-nut to secure the inner race to the roller screw shaft which introduces an additional part and failure point. The thrust bearing acts as a “combination bearing” that provides no only radial support required by the roller screw shaft but also reacts all the thrust loads generated by operating the actuator.

Mounted to the distal end of the main housing is an optional volume compensator housing with an internal filling cavity filled with a lubricating fluid and an internal air cavity. Located between the filling cavity and the air cavity are two bellows or a single sliding piston. Located on the opposite side of the bellows or piston is an air cavity that communicates with outside atmosphere. During operation, lubricating fluid flows back and forth from the filling cavity to the main housing thereby lubricating the extension tube, the roller screw nut and the thrust bearing. As the roller screw nut moves axially over the roller screw shaft, the lubricating fluid flows automatically back and forth between the volume compensator housing and the main housing to not only lubricate the parts but also act as a heat transfer media.

### BRIEF DESCRIPTION OF THE DRAWINGS

FIG. 1 is a perspective view of a self-lubricating linear drive actuator shown herein.

FIG. 2 is a sectional perspective view of the linear drive actuator shown in FIG. 1.

FIG. 3 is a sectional, side elevational view of the improved liner drive actuator shown in FIG. 1.

FIG. 4 is a sectional, side elevational view of the motor housing attached to the actuator housing.

FIG. 5 is a sectional, side elevational view of the rear section of the actuator housing showing the motor drive gear, the motor drive shaft, the idler gear, and the actuator gear contained therein.

FIG. 6 is a sectional, side elevational view of the rear, lower section of the actuator housing showing the actuator drive shaft connected to the thrust bearing disposed around the proximal end of the roller screw shaft.

FIG. 7 is a sectional side elevational view of the roller nut attached to the roller screw.

FIG. 8 is a sectional side elevational view of the volume compensating housing mounted over the distal area of the main housing.

FIG. 9 is a rear end elevational view of the actuator housing showing the relative locations of the motor drive gear, the motor gear drive shaft, the idler gear, and the actuator gear.

FIG. 10 is a perspective view of a piston style volume compensation housing mounted on the rear surface of the main housing.

FIG. 11 is a sectional, top plan view of the volume compensation housing shown in FIG. 10.

### BEST MODE FOR CARRYING OUT THE INVENTION

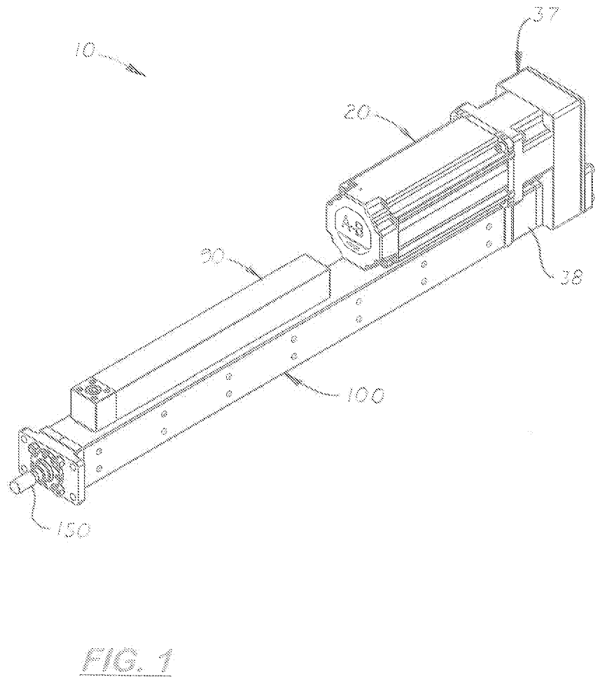

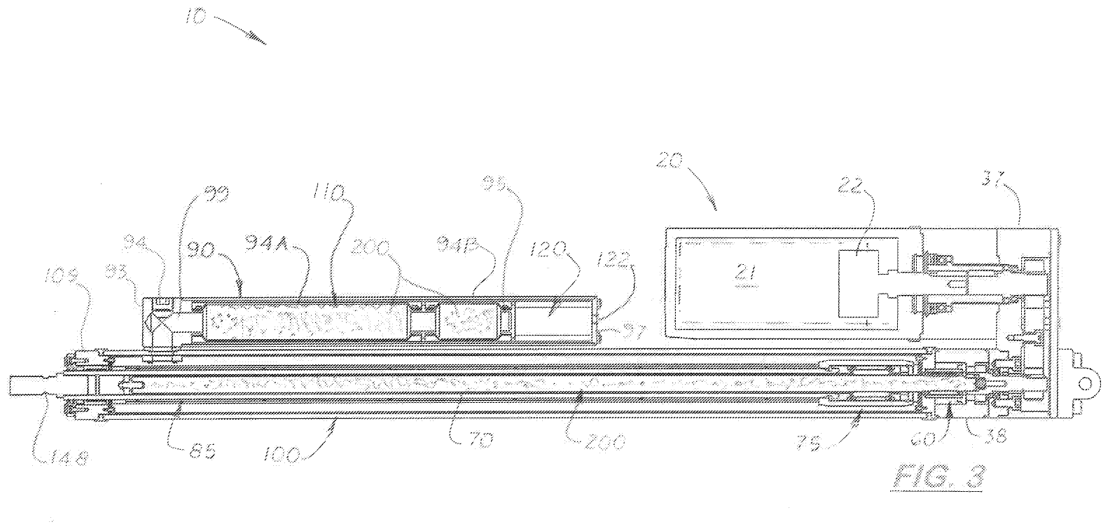

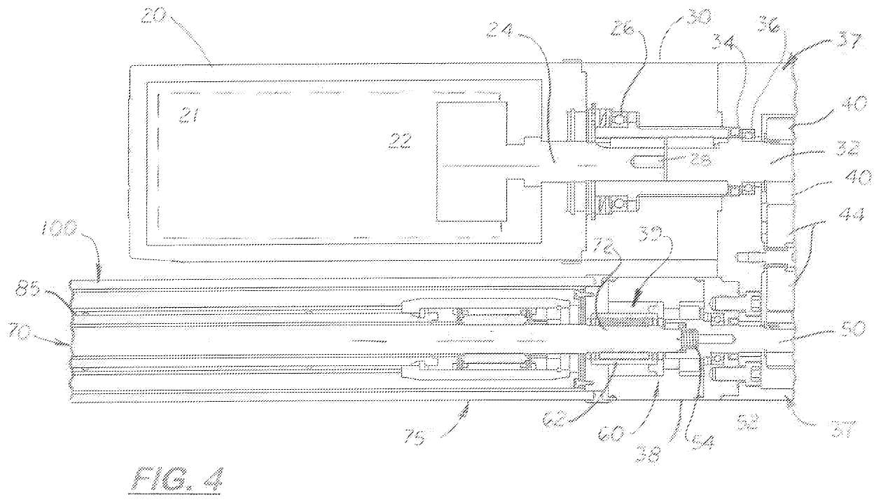

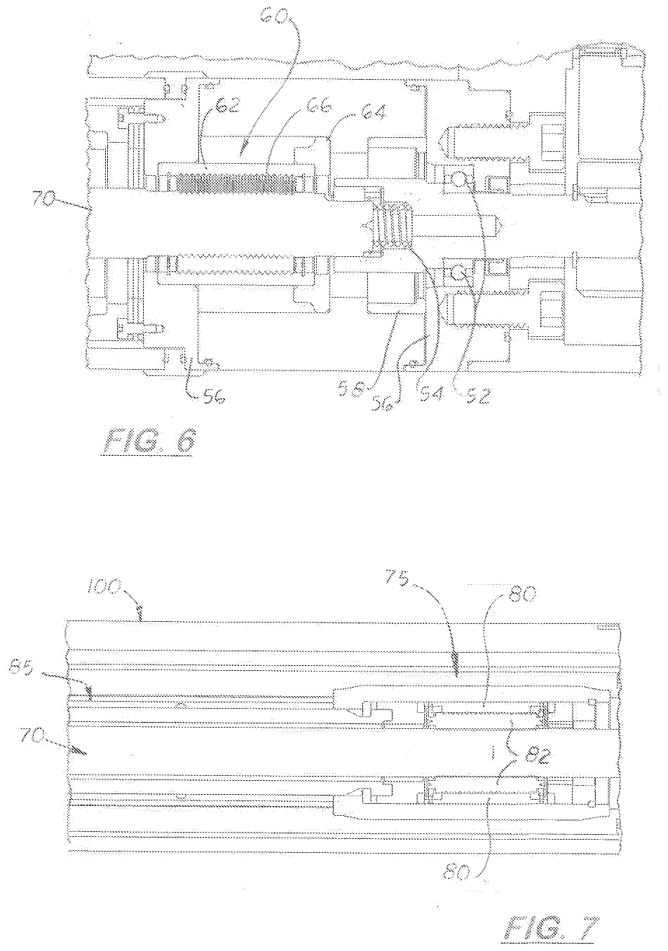

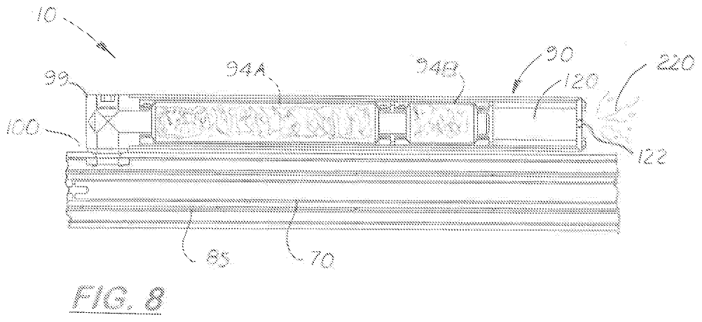

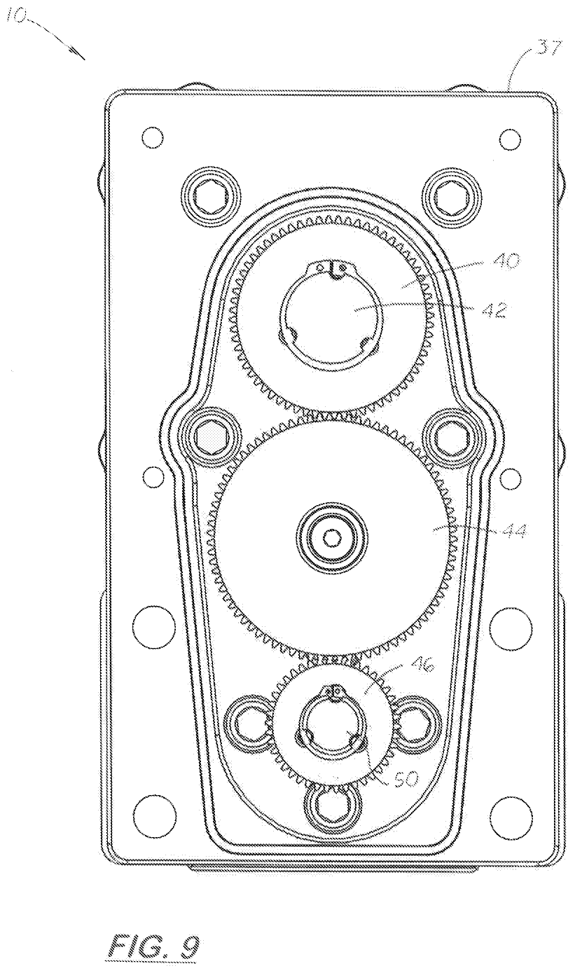

Disclosed herein in FIGS. 1-9 is a linear drive actuator 10 with a motor housing 20 containing at least one motor 21 with a drive shaft 24 that attaches to a gear housing 37 containing a motor drive gear 40, a motor gear drive shaft 32, an idler gear 44, an actuator gear 46, and an actuator drive shaft 50. Attached to the front surface of the gear housing 37 and below the motor housing 20 is an elongated, hollow main housing 100 containing a roller screw shaft 70, a roller screw nut 75 and an elongated extension tube 85. During assembly, the roller screw nut 75 is mounted on the roller screw shaft 70 and the elongated extension tube 85 is abutted against the roller screw nut 75. During operation, the motor 21 is activated with causes the roller screw shaft to rotate. A thrust bearing 60 is mounted on the distal end of the roller screw shaft 70 to keep it axially fixed inside the main housing 100.

The motor housing 20 includes a servo motor 21 with an armature 22 connected to a motor drive shaft 24. The motor housing 20 is attached to the front surface of the gear housing 37. In the gear housing 37 is a motor drive shaft port that includes a ball bearing 26 that supports the drive shaft 24. Axially aligned with the motor drive shaft 24 is a motor gear drive shaft 40 that extends into a gear cavity formed on the rear surface of the gear housing 37. A key 28 is disposed between the end of the motor drive shaft 24 and the motor gear drive shaft 32 to radially connect the shafts together. A shaft seal 34 and a ball bearing 36 are used support the motor gear drive shaft 32 in the gear housing 37.

Mounted adjacent to the rear surface of the motor housing 20 is a gear housing 37. In the embodiment shown in the Figs, the gear housing 37 is configured so that the axis of the motor drive shaft 24 is parallel to the longitudinal axis of the roller screw shaft 70. In should be understood that the gear housing may be configured so that the motor drive shaft 24 is axially aligned with the roller screw shaft 70.

Attached to the gear housing 37 is an idler gear 44 that meshes with the motor drive gear 40. Below the idler gear 44 is an actuator drive gear 46 that meshes with the idler gear 44. The idler gear 40 is mounted on an axle that extends rearward from the gear housing 37. The actuator driver gear 46 is securely attached to a perpendicularly aligned actuator drive gear shaft 50 with extends forward toward the front surface of the gear housing 37. A support frame 56 and frame spacers 58 are used to support the distal end of the actuator drive gear shaft 50 inside the gear housing 37.

Located inside the lower section of the gear housing 37 is a thrust bearing 60.

Formed on the front surface of the gear housing or on the secondary housing 38 is a thrust bearing cavity. During assembly, the proximal end of the elongated roller screw shaft 70 is inserted into the thrust bearing cavity. The thrust bearing cavity is configured to house a cylindrical outer race used on the thrust bearing 60. Formed on near the proximal end of the roller screw shaft 70 in an integral formed cylindrical inner race 72.

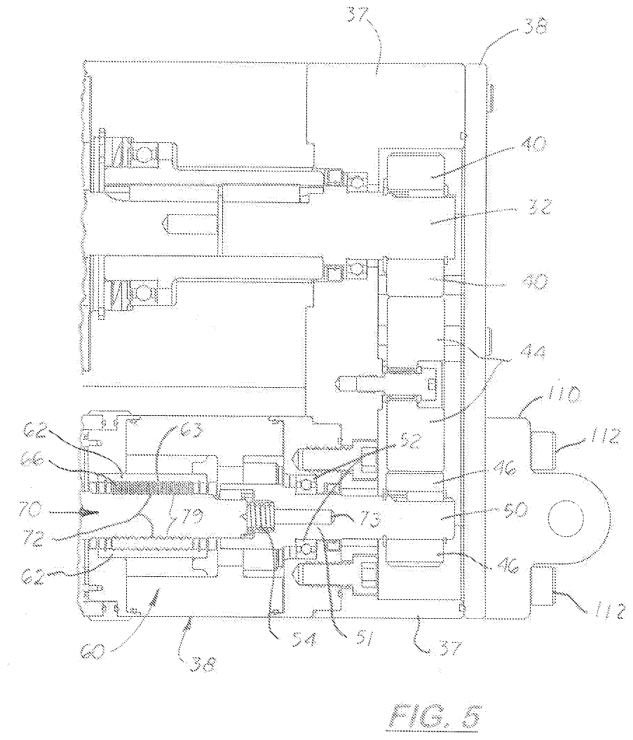

The roller screw shaft 70 may be solid or it may include a longitudinally aligned center bore 78. Formed on the outside surface of the inner race 72 are external non-helical grooves 79, (see FIG. 5). Formed on the outside surface of the section of the roller screw shaft 70 that extends forward from the inner race 72 to the distal end of the roller screw shaft 70 are helical threads 74.

The thrust bearing cavity formed on the gear housing or the secondary housing 38 is configured to receive and hold the outer race 62 on the thrust bearing 60 so that the outer race 62 is held in a fixed location. Formed on the inside surface of the outer race 62 are non-helical grooves 63. Disposed against the outer race 62 are a plurality or axially aligned rollers 66. Each roller 66 includes a plurality of teeth configured to mesh with the non-helical grooves formed on the outer race 62 and on the inner race 72.

During assembly, the roller screw shaft 70 is axially aligned with the actuator drive gear shaft 50. Formed on the proximal end of the roller screw shaft 70 is a narrow neck 73 that extends into a complementary shaped bore 51 formed on the actuator drive gear shaft 50. Mounted on the neck is a coil spring 54 and applies a forward extending biasing force to the roller screw shaft 70. A ball bearing 52 is used to support the neck 73 in the gear housing 37.

Axially aligned over the roller screw shaft 70 is an elongated, hollow main housing 100. Formed on the inside the main housing 100 is lubrication space. The main housing 100 includes a proximal end 102 that connects to the front surface of the gear housing. The roller screw nut 75 is similar to the roller screw nut shown in U.S. Pat. No. 2,683,379 (Strandgren) which is now incorporated herein. The roller screw nut 75 includes an outer nut holder 77 that surrounds an outer race 80. Located inside the outer race 80 is a plurality of rollers 82. Formed on the outer race 80 and the rollers 82 are a plurality of helical threads that mesh and cause the roller nut 75 to move axially in opposite directions over the roller screw shaft 70 when rotated in opposite directions. On each end of the roller screw nut 82 in an alignment spacer 83 and a pre-load ring 84.

When the roller screw shaft 70 is rotated, the roller screw nut 75 is configured to move longitudinally over the roller screw shaft 70. Formed on the distal end of the roller nut 75 is a recessed circular groove that receive a tab 87 formed on the proximal end of an extension tube 85 to lock the extension tube 85 to the roller screw nut 75. The distal end of the extension tube 85 is closed with a clevis 148. Attached to the distal end of the main housing 100 is a sealing end cap 108. During assembly, the roller screw shaft 70 is inserted into the roller screw nut 75 and the roller screw nut 75 and the extension tube 85 are axially aligned and inserted into the main housing 100. The clevis 148 is then attached to the distal the extension tube 85.

The linear drive actuator 10 includes an optional lubricating and cooling system, generally indicated by reference number 88, used to continuously lubricate and cool the actuator 10 during operation. The system 88 includes an elongated volume compensation housing 90 axially aligned and mounted over the main housing 100 and in front of the motor housing 20. The volume compensation housing 90 is shown mounted on the top surface of main housing 100. It should be understood that the volume compensation housing 90 may be mounted on the bottom or sides of the main housing 100. The volume compensation housing 90 includes a longitudinally aligned center bore with a proximal end and a distal end.

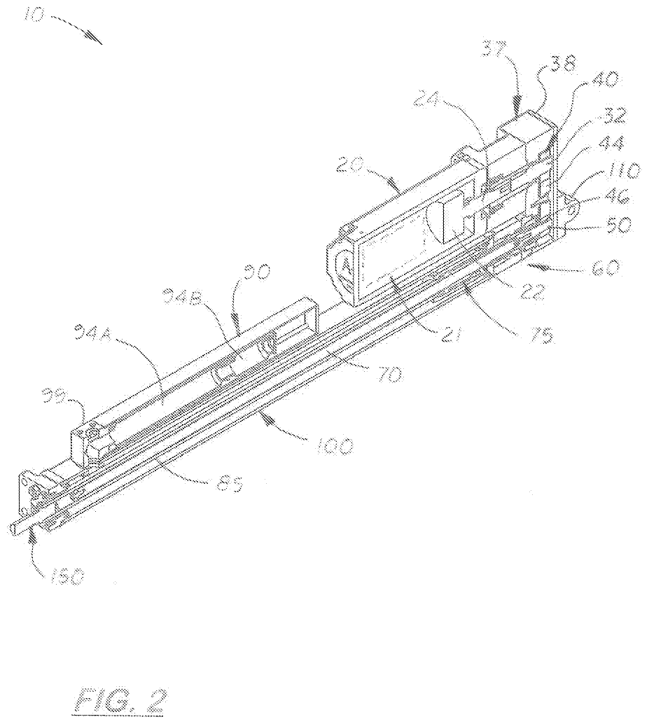

In the embodiment show in FIGS. 2, 3, and 8, located inside the volume compensation housing 90 is at least one bellows 94 that communicates with an L-shaped fitting 99 at the end cap 108 that attaches to the main housing 10.

Also located inside the volume compensation housing 90 is a sliding, transversely aligned plug 95 that divides the housing 90 into a front filling cavity 100 containing at least one bellow 94 and a rear air cavity 120 filled with air 220. (In the Figs two bellows 94A, 94B are shown serially connected together). Formed on the rear end plate 97 of the housing 90 is an air vent 122. During assembly, the extension tube 85 is retracted inside the main housing 100 and lubricating fluid 200 is dispensed into the filling port formed on the front end cap 93. Lubricating fluid 200 fills the bellows 94A causing it to expand and then flows into the extension tube 85, the roller screw nut 75, the thrust bearing 60 and into the space between the main housing 100 and the extension tube 85. The plug 95 is force rearward expelling air and reducing the volume of the air cavity 120 inside the volume compensating housing 90.

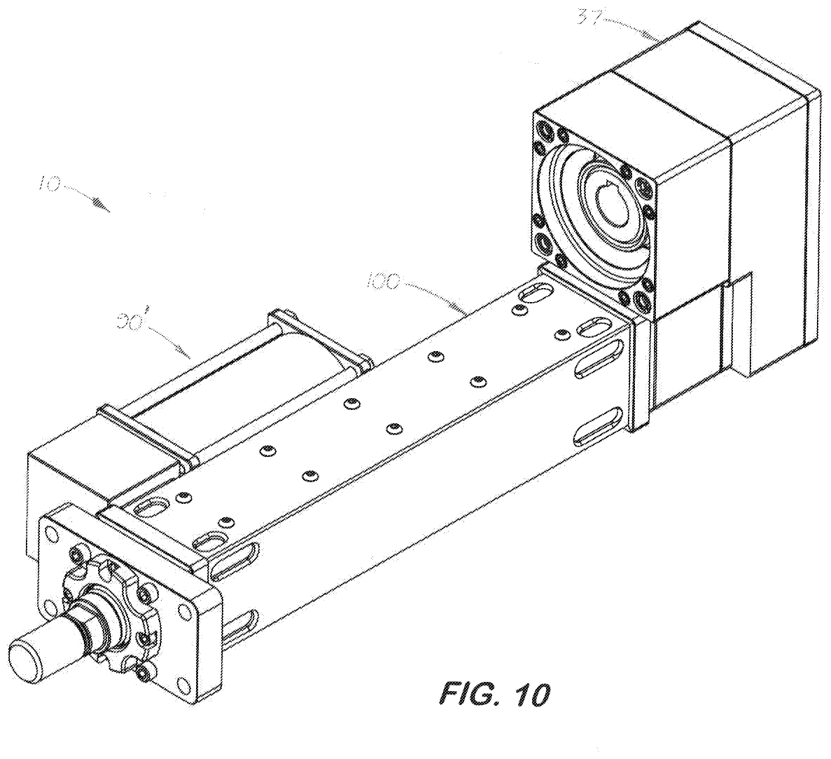

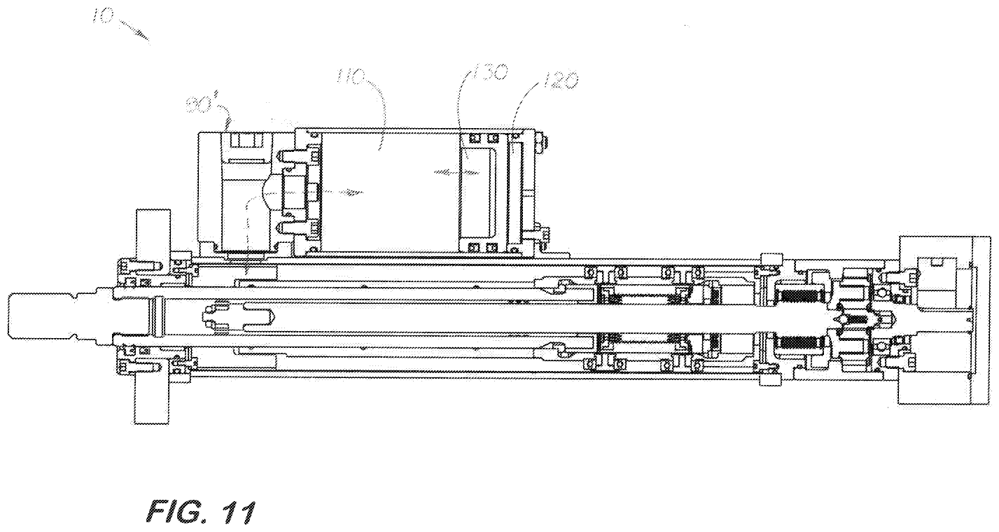

In another embodiment of the volume compensation housing 90′ shown in FIGS. 10 and 11, the bellows 94 is replaced by a single sliding piston 130 that moves back and forth in the housing expanding and collapsing the filling cavity 110. In both embodiments, the extension or retraction of the elongated shaft 70 causes increase or decrease, respectively, in internal lubricating fluid pressure inside the main housing 100. The change in lubrication fluid pressure in the main housing causes either the bellows 94A, 94B or the piston 130 to move back and forth and compensate for change in volume inside the main housing 100 caused by extension or retraction of the elongated shaft 70.

In compliance with the statute, the invention described has been described in language more or less specific as to structural features. It should be understood, however, that the invention is not limited to the specific features shown, since the means and construction shown comprises the preferred embodiments for putting the invention into effect. The invention is therefore claimed in its forms or modifications within the legitimate and valid scope of the amended claims, appropriately interpreted under the doctrine of equivalents.

### INDUSTRIAL APPLICABILITY

This invention may be used in industries that use linear drive actuators

More particularly, this invention will used in industries that use linear drive actuators with roller screws.

1. A linear drive actuator, comprising:
a. a motor housing (20) containing a motor (21) with a drive shaft;
b. a motor drive gear (40) shaft coupled to the drive shaft (32);
c. an idler gear (44) that meshes with the motor drive gear (40);
d. a roller screw gear that meshes with the idler gear (44);
e. an actuator drive shaft (50) coupled to the actuator gear;
f. an elongated roller screw shaft (70) axially aligned and connected to the actuator drive shaft (50), the elongated roller screw shaft (70) includes an inner race (71) formed on a proximal end with external non-helical grooves (73) formed thereon;
g. a thrust bearing (60) coaxially aligned over the proximal end of the roller screw shaft (70), the thrust bearing (60) includes an outer race (80) with internal non-helical grooves, and a plurality of axially aligned rollers (66) disposed inside the outer race (80), each said roller (66) includes external, non-helical threads configured to simultaneously engage said non-helical grooves on said outer race (80) and said non-helical grooves on the inner race (71) and thereby prevent the roller screw shaft (70) from translating axially when the roller screw shaft (70) is rotated;
h. a roller screw nut (75) configured to move axially over the roller screw shaft (70) when the roller screw shaft (70) is rotated;
i. an elongated main housing (100) with a proximal end opening, a distal end opening and an internal cavity, the elongated main housing (100) being filled with a lubricant (200); and,
j. a hollow extension tube (85) axially aligned and around the roller screw shaft (70), the extension tube (85) being coupled to the roller screw nut (75) so the extension tube (85) moves axially over the roller screw shaft (70) when the roller screw shaft (70) is rotated inside the roller screw nut (75), the extension tube (85) being sufficient in length to extend through the main housing when the roller screw shaft (70) is rotated inside the roller screw nut (75).

2. The linear drive actuator (10), as recited in claim 1, further including a volume compensation housing (90) with a fluid filling cavity filled with a lubricant (200), the volume compensation housing (90) configured to adjust the flow of the lubricant in and out of the main housing as the roller screw nut (75) moves axially over the roller screw shaft (70).

3. The linear drive actuator (10), as recited in claim 2, where the volume compensation housing (90) includes at least one bellows.

4. The linear drive actuator (10), as recited in claim 2, where the volume compensation housing (90) includes a piston (130).

5. A linear drive actuator (10), comprising:
a. a motor housing (20);
b. a motor (21) located in the motor housing (20), the motor (21) includes a drive shaft;
c. a thrust bearing (60) including an outer race with internal non-helical grooves and a plurality of axially aligned rollers disposed inside the outer race with a plurality of rollers each including external, non-helical threads;
d. a roller screw shaft (70) with a proximal end and a distal end, the proximal end being coupled to the drive shaft on the motor, formed near the proximal end of the roller screw shaft is an inner race with a plurality of non-helical grooves formed thereon configured to mesh with the non-helical threads on the rollers used with the thrust bearing (60) and thereby prevent the roller screw shaft (70) from translating axially when the roller screw shaft (70) is rotated;
e. a roller screw nut (75) mounted around the roller screw shaft (70), the roller screw nut (75) configured to move axially over the roller screw shaft (70) when the roller screw shaft (70) is rotated, the roller screw nut (70) includes an outer nut housing;
f. an elongated main housing (100) with a proximal end opening, a distal end opening and an internal cavity, the elongated main housing (100) being filed with a lubricant (200); and
g. an extension tube (85) axially aligned inside the elongated main housing and around the roller screw shaft, the extension tube being coupled to the roller nut so the extension tube (85) moves axially over the roller screw shaft (70) and inside the main housing (100) when the roller screw shaft (70) moves axially inside the main housing (100), the extension tube (85) being sufficient in length to extend through the elongated main housing (100) when the roller screw shaft (70) is rotate inside the roller screw nut (75).

6. The linear drive actuator (10), as recited in claim 5, further including a volume compensation housing (90) with a fluid filling cavity filled with flowing lubricant (200), the volume compensation housing (90) configured to adjust the amount oil in the main housing (100) as the roller screw nut (75) moves axially over the roller screw shaft (70).

7. The linear drive actuator, as recited in claim 5, where the volume compensation housing (90) includes at least one bellows.

8. The linear drive actuator, as recited in claim 7, where the volume compensation housing (90) includes a sliding piston (130).
